(19) United States
(12) Patent Application Publication
(10) Pub. No.: US 2010/0097624 A1
(43) Pub. Date: Apr. 22, 2010

(54) IMAGE FORMING APPARATUS, IMAGE INSPECTION METHOD, AND STORAGE MEDIUM

(75) Inventor: Satoshi Hirakawa, Tachikawa-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/579,297

(22) Filed: Oct. 14, 2009

(30) Foreign Application Priority Data
Oct. 16, 2008 (JP) 2008-267730

(51) Int. Cl. G06K 15/02

(52) U.S. Cl. 358/1.12; 358/1.18; 382/112; 358/1.15

(57) ABSTRACT

An information processing apparatus obtains an inspection image output mode to have an inspection image mixed in an output of image data and outputs the inspection image with the output of the image data. The inspection image is used to inspect a status of an image printed by an image forming apparatus based on image data generated according to a print job specified by a user. The information processing apparatus, according to the obtained inspection image output mode, generates printing control information to output the image data and the inspection image, which is mixed in the output of the image data. The information processing apparatus sends a print job, including the generated printing control information, to the image forming apparatus.

### BACKGROUND OF THE INVENTION

1. Field of the Invention

The present invention relates to an information processing apparatus, and also to an image forming system, which includes an image forming apparatus that processes print jobs received from the information processing apparatus.

2. Description of the Related Art

In the printing market, including Print On Demand (POD) service, the inspection of print products is an extremely important process in quality evaluation of print products.

On actual printing job sites, inspection operators inspect print products sheet by sheet to check print quality. As an inspecting method, print products are divided into small lots and some sheets from each lot are extracted and inspected for print quality.

If a lot includes a print product that is determined not to meet a standard quality as a result of an inspection step, this lot is discarded. This method, which does not require stopping the image forming apparatus for each inspection, is effective in preventing a decline in productivity of print products.

In the above method, however, while monitoring an actual print status, printing operators need to extract and inspect print products, perform control based on inspection results, and manage the operators and the work place.

Therefore, it is difficult to apply the above inspection operation to printing services, such as POD, in which the scale of print product varies with each order.

Under those circumstances, a method for inspecting the quality of print products has been developed, which reduces burden on the operators as discussed in Japanese Patent Application Laid-Open No. 2007-89095.

Japanese Patent Application Laid-Open No. 2007-89095 discusses a method of storing image data when data on print products is received after printing has been completed, making the image reading apparatus read print products, and verifying quality of print products by comparing the products with image data.

However, in a system of inspecting print quality by reading an image, a print product cannot be inspected until the whole print product has been read by the image reading unit in the image forming apparatus. For this reason, in large-volume printing such as a POD print service, the above-described inspection printing often increases burden on the operators, and necessitates a large-volume storage device.

If all copies printed in, say, the POD service described above have to be output before they are inspected, the work efficiency may decrease.

### SUMMARY OF THE INVENTION

The present invention is directed to a method capable of inspecting inspection images, which are output between print jobs because the inspection images are mixed in with the print jobs, without interrupting the printing process, according to the print jobs which are being received.

According to an aspect of the present invention, an image forming apparatus is configured to process a print job received from an information processing apparatus. The image forming apparatus includes a plurality of paper discharge units configured to discharge a print output printed by a printing unit, a print control unit configured to have an inspection image mixed in an output of the image data and to output the inspection image with the output of the image data, the inspection image being used to inspect a state of an image printed by the printing unit based on image data generated according to the print job, a paper discharge control unit configured to switch between a paper discharge destination to receive a print output printed by the printing unit based on the inspection image data and another paper discharge destination to receive a print output printed by the printing unit based on image data of each page, a reading unit configured to read an inspection image of the print output discharged to the paper discharge unit, and a display unit configured to compare the inspection image data read by the reading unit with evaluation image data previously stored to check a degree of agreement therebetween, and to display a result of print quality inspection of a print output stack printed based on the image data of each page.

According to an exemplary embodiment of the present invention, the print status of print output stacks can be inspected by inspecting the inspection images which are mixed between print jobs and output from between the print jobs without interrupting the printing process according to print jobs which are received.

A print output stack which is to be determined as defective can be easily identified by evaluating and displaying a result of an inspection process executed on every print output stack discharged.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image forming system, including an image forming apparatus and an information processing apparatus according to an exemplary embodiment of the present invention.

FIG. 2 is a plan view illustrating an example of an operation unit in FIG. 1.

FIG. 3 illustrates an example of a user interface displayed on a display apparatus of a host computer in FIG. 1.

FIG. 4 is a flowchart illustrating an example of a data processing procedure in an information processing apparatus according to an exemplary embodiment of the present invention.

FIG. 5 illustrates an example of a print output printed by the printing unit of the image forming apparatus in FIG. 1.

FIG. 6 is a flowchart illustrating an example of a data processing procedure according to an exemplary embodiment of the present invention.

FIG. 7 illustrates an example of a user interface displayed on a touch panel of the operation unit of the image forming apparatus in FIG. 1.

FIG. 8 is a flowchart illustrating an example of a data processing procedure in the image forming apparatus according to an exemplary embodiment of the present invention.

FIG. 9 is a flowchart illustrating an example of a data processing procedure in the image forming apparatus according to an exemplary embodiment of the present invention.

FIG. 10 illustrates an example of a user interface displayed on a touch panel of the operation unit in the image forming apparatus in FIG. 1.

FIG. 11 illustrates a memory map of a storage medium to store various types of data processing program readable by an information processing apparatus according to an exemplary embodiment of the present invention.

### DESCRIPTION OF THE EMBODIMENTS

Various exemplary embodiments, features, and aspects of the invention will be described in detail below with reference to the drawings.

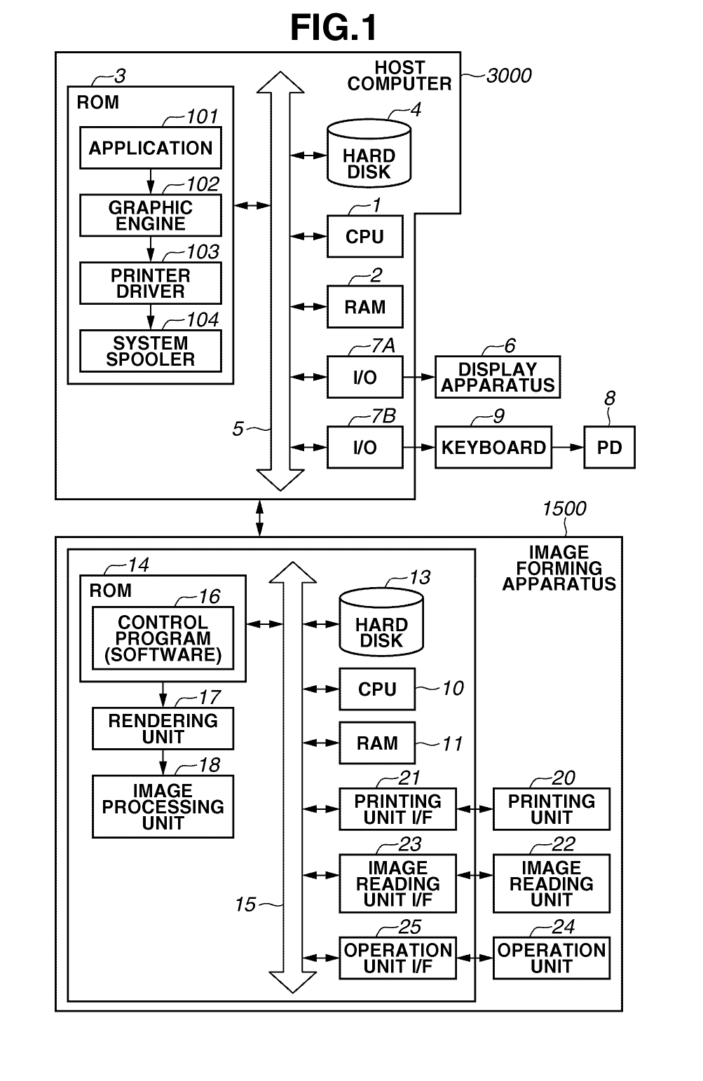

FIG. 1 is a block diagram illustrating a configuration of an image forming apparatus, including an image forming apparatus and an information processing apparatus according to a first exemplary embodiment of the present invention.

In the present exemplary embodiment, an image forming system is formed by connecting a host computer 3000 and an image forming apparatus 1500 via the internet and a network. Therefore, the host computer 3000 and the image forming apparatus 1500 each have a communication interface, including a network controller, not shown. This system may be formed by a single unit of equipment or multiple items of equipment as long as the function of the present invention can be performed. The present invention can be applied to a system formed by connecting separate sections via a network, such as a LAN (local area network) or a WAN (wide area network) and under this condition processing is executed. The host computer 3000 is not limited to only one, but this invention can be applied to a type of system in which a plurality of host computers 3000 are connected, and requests from the host computers are coordinated, so that a printing process can be carried out.

In the present exemplary embodiment, an example of an image forming apparatus, which outputs content, obtained by a browser of a host computer, to the image forming apparatus via a printer driver, is described below. Information in print jobs executed by the printer driver is not limited to content, but maybe objects generated by a draw command which is generated by an application. Objects include, but are not limited to, text, graphics, and images, or their combinations.

In FIG. 1, the host computer 3000 includes a CPU 1, RAM 2, a ROM 3, and a hard disk 4, all connected to a system bus 5. The host computer 3000 uses the CPU 1 to execute processes based on various programs stored in a program ROM of the ROM 3. The CPU 1 controls the devices connected to the system bus 5 in a comprehensive manner. In the hard disk 4 which will be described below, an operating system (OS) is installed. After the OS is loaded in the RAM 2, the execution of various types of applications and drivers is managed on the OS. Although the printer driver 103 stored in the ROM 3 is illustrated in the present exemplary embodiment, the printer driver 103 may be installed in the hard disk 4 and then loaded in the RAM 2 under management of the OS.

The RAM 2 serves as a main memory or work memory for the CPU 1, for example.

The hard disk 4 functions as the storage area of program data, for example.

The CPU 1 opens various types of registered windows or executes various types of data processing according to commands from the user who uses a pointing device (PD) 8, such as the mouse cursor, on the display apparatus 6. The PD 8 is connected to the system bus 5 via the keyboard 9 and an I/O interface 7B. The display apparatus 6, which can be any of a CRT and a LCD display or the like, is connected to the system bus 5 via an I/O interface 7A.

In a host computer 3000 configured as described, when the user issues a command to execute printing, the user starts with opening a window to specify settings for printing on the display apparatus 6. On the user interface in the window displayed on the display apparatus 6, the user can select settings for a print processing method to the printer driver, such as settings of a printer or selection of a print mode.

An application 101, a graphic engine 102, printer driver 103, and a system spooler 104 are programs stored in the ROM 3 as illustrated in FIG. 1.

When those programs are read into the RAM 2 and executed by the CPU 1, various processes are executed. More specifically, application 101 executes a process according to flowcharts which will be described below.

When application 101 executes a process it is loaded from the ROM 3 to the RAM 2, and the CPU 1 executes the process according to the loaded application 101. This explanation equally applies to the graphic engine 102, the printer driver 103, and the system spooler 104, as well as control software to be described below.

In the image forming apparatus 1500 in FIG. 1, the image forming apparatus 1500 is controlled by the CPU 10. The CPU 10 of the image forming apparatus operates according to a control program 16 stored in the program ROM of the ROM 14, for example. The control program 16 analyzes a print job received from the host computer 3000, extracts print control information, and outputs this information to a rendering unit 17. The rendering unit 17 generates raster image data from a drawing command included in the print control information and outputs the data to a printing unit 20. In this operation, an image processing unit 18 performs image processing, including rotation or layout, on image data generated by the rendering unit 17 using the RAM 11.

The CPU 10 causes image data to be output to the printing unit 20 (printer engine) via the system bus 15, and the CPU 19 causes the image data read by the image reading unit 22 to be stored in a hard disk 13 via the system bus 15. The program ROM of the ROM 14 stores a control program (software) for the CPU 10. The image reading unit 22 usually reads a document image. In addition, when a command to perform an inspection process is received via the user interface, which will be described below, the image reading unit 22 reads a print output containing inspection images which are mixed between print jobs and discharged from between the print jobs during the ongoing printing process.

The image reading unit 22 may be configured as an external device which is connected via an interface. When reading images as an inspection output, plural pieces of inspection output are read continuously by an automatic document feeder (ADF).

The CPU 10 is configured to be able to communicate with the host computer 3000, and can send information, for example, from inside the image forming apparatus 1500 to the host computer 3000. The RAM 11 functions as a main memory or work memory for the CPU 10. The hard disk 13 has an area reserved for storage of image data, for example. The hard disk 13 also stores information used to inspect inspection images. The printing unit 20 is connected to the system bus 15 via a printing unit I/F 21. The image reading unit 22 is connected to the system bus 15 via the image reading unit I/F 23.

The image forming apparatus 1500 includes an operation unit 24. The operation unit 24 is connected to the system bus 15 via an operation unit I/F 25.

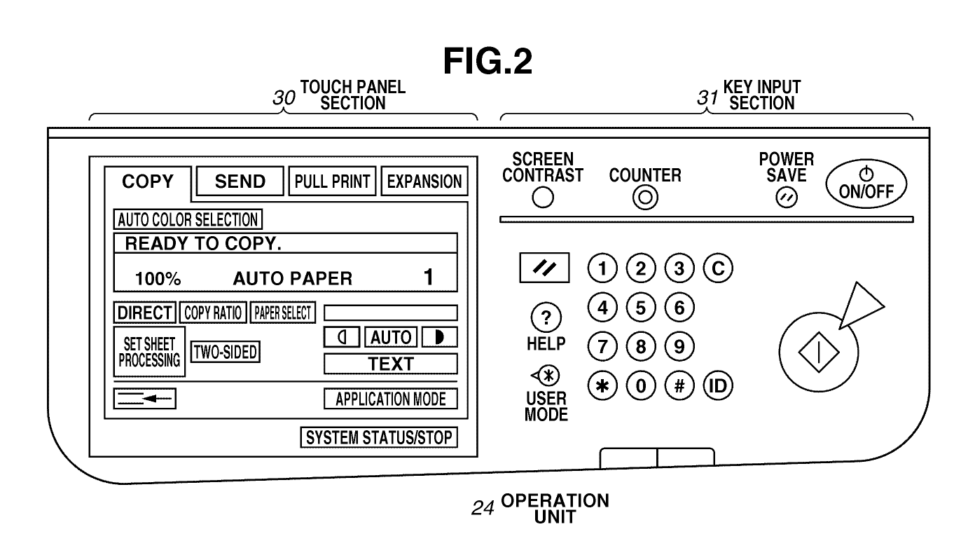

The operation unit 24 is divided into a touch panel section 30 and a key input section 31 as illustrated in FIG. 2. The touch panel section 30 indicates a current status of the image forming apparatus. According to the present exemplary embodiment, the image forming apparatus 1500 includes a unit configured to shift an output paper discharge position relative to a paper discharge destination in the direction perpendicular to the paper conveyance direction, so that print output stacks can be shifted collectively for each print job when they are discharged. Timing to shift print output stacks is at each print output printed for an inspection image, which will be described below. In the present exemplary embodiment, the shift timing is generated at periods of a specified number of pages or copies.

The shift mechanism is well known as discussed in Japanese Patent Application Laid-Open No. 06-298435.

FIG. 2 is a plan view illustrating an example of the operation unit 24 in FIG. 1. Roughly divided, the operation unit 24 in the present embodiment includes a tough panel section 30 and a key input section 31 provided with hard keys and a display unit. The inspection image printing function of the image forming apparatus illustrated in FIG. 1 is described below.

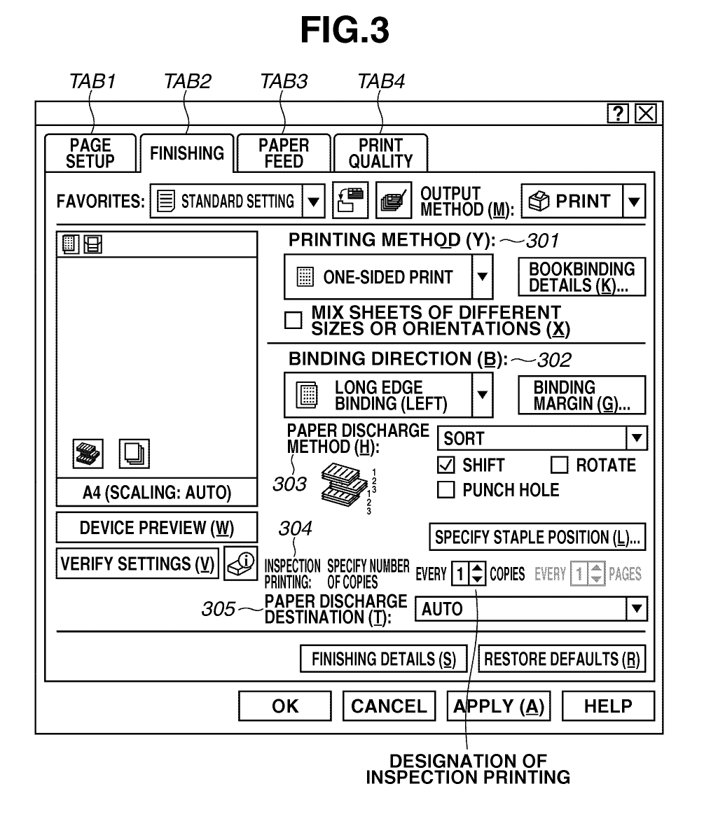

FIG. 3 illustrates an example of the user interface displayed on the display apparatus 6 of the host computer 3000 in FIG. 1. The user of the host computer 3000 issues a command to perform inspection printing to the control program 16 in the image forming apparatus 1500. This user interface is supposed to be a built-in function in the printer driver 103 stored the hard disk 4, but a dedicated user interface may be used.

In FIG. 3, TAB1 to TAB4 are tab sheets, and at this moment the tab sheet TAB2 for finishing is selected. On this tab, the user can select items indicated in the boxes related to a printing method 301, a binding direction 302, a paper discharge method 303, inspection printing 304, and a paper discharge destination 305.

In the example in FIG. 3, at the inspection printing 304 to set inspection printing, the user can specify a print period of inspection images in inspection printing as a number of pages or a number of copies, for example. The printer driver 103 determines the status of the inspection image output mode to be specified and specifies the inspection image print period for inspection printing as a number of pages or a number of copies, for example. The printer driver 103 can include information to output inspection images from the image forming apparatus 1500 in the print control information of print jobs to be generated. The information also includes paper discharge destination information to specify a paper discharge destination.

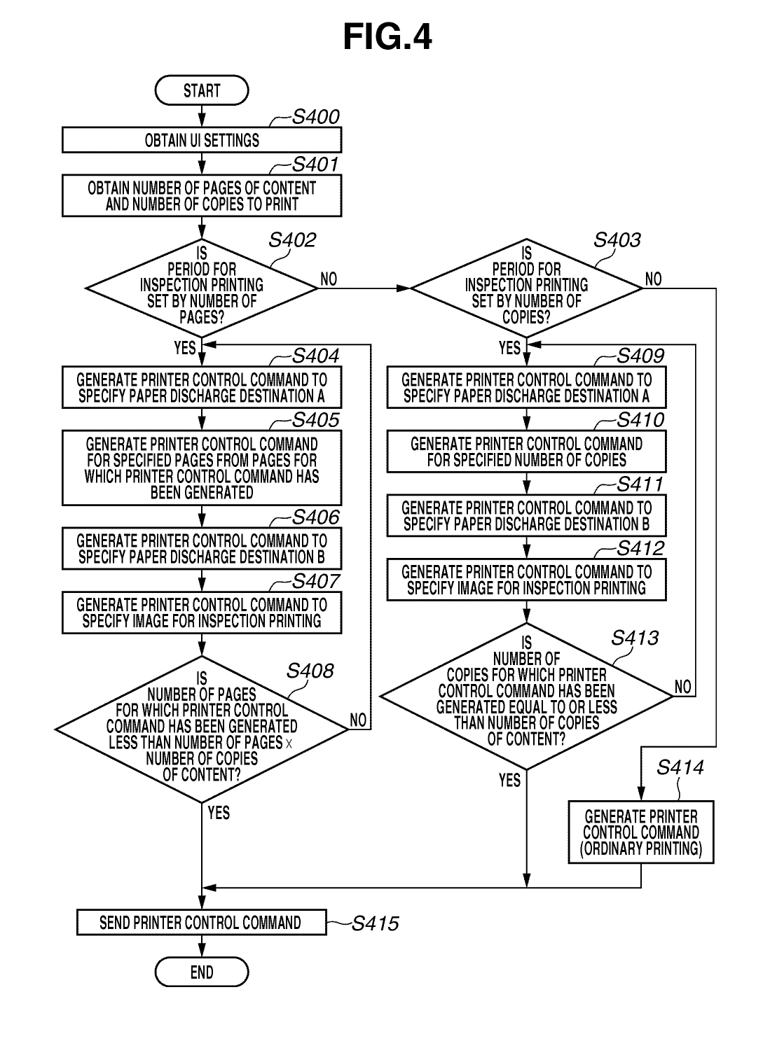

FIG. 4 is a flowchart illustrating an example of a data processing procedure in the information processing apparatus according to an exemplary embodiment of the present invention. This example illustrates a case where job processing is performed when the printer driver 103 inserts an inspection image to generate a printer control command at specified periods. When receiving an arbitrary content print command from the graphic engine 102 in the host computer 3000, the printer driver 103 executes the above process. Each step is carried out when the CPU 1 operates the printer driver 103, which is loaded in the RAM 2.

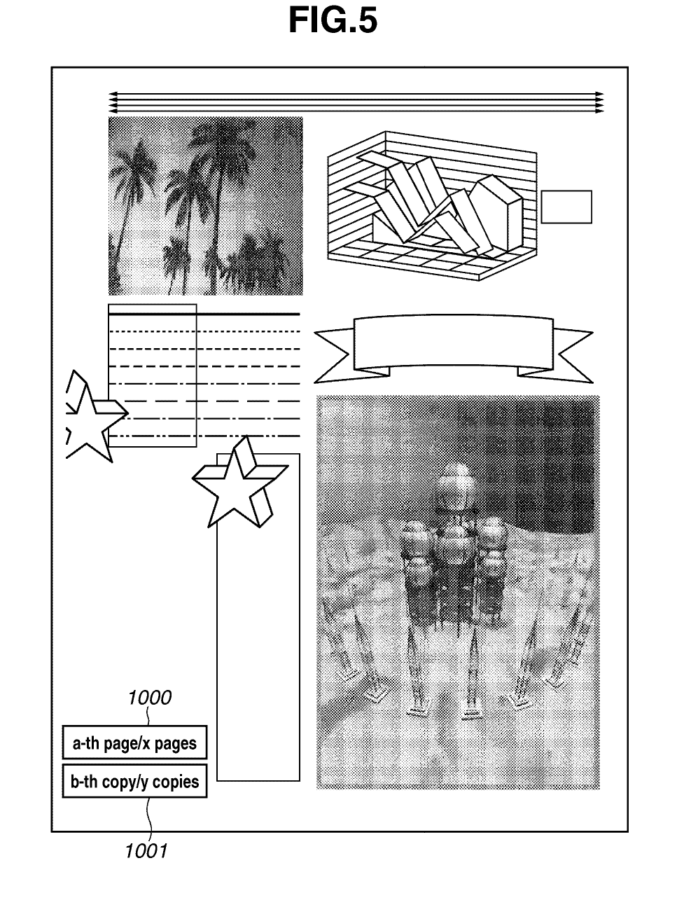

In the present exemplary embodiment, the inspection image used here is arbitrary image data to check the print quality of a color chart, shown, as an example, in FIG. 5, which is stored previously in the hard disk 4 of the host computer 3000.

In step S400, the printer driver 103 receives settings specified by the user at the user interface illustrated in FIG. 3. In step S401, the printer driver 103 obtains a number of pages and a number of copies of content data to be printed, from a print command received from the graphic engine 102.

In step S402, if the printer driver 103 determines whether the setting of inspection printing is not specified by a number of pages, then in step S403, the printer driver 103 determines whether the setting of inspection printing is specified by a number of copies. In short, in steps S402 and S403, it is determined whether the setting of in inspection printing has been finished. In the present exemplary embodiment, the setting of inspection printing means to determine whether a period for inspection printing is set by a number of pages or a number of copies.

If the printer driver 103 determines in step S402 that the print period of an obtained inspection image is set by a number of pages, the process proceeds to step S404. In step S404, the printer driver 103 generates a printer control command to specify a discharge destination for a print product. In this case, the printer driver 103 generates a printer control command to specify a paper discharge destination A.

In step S405, the printer driver 103 generates printer control commands for a specified number of pages from the number of pages of already generated printer control commands. The number of pages corresponds to a value specified by the user at the inspection printing 304 in FIG. 3.

In step S406, the printer driver 103 generates a printer control command to specify a paper discharge destination B for a print product. In step S407, the printer driver 103 generates a printer control command for an inspection image. A printer control command is added with a command to print information about a number of pages or a number of copies, which have been generated at this timing, at a specified position of the inspection image by overwriting. In the present exemplary embodiment, the paper discharge destinations A and B are associated with respective different paper discharge trays. The paper discharge tray at the paper discharge destination A is provided with a mechanism to shift the position of paper to be discharged. Therefore, paper can be ejected to different paper discharge positions in increments of a specified number of pages or copies.

FIG. 5 illustrates an example of a print output printed by the printing unit 20 in FIG. 1. This example shows an inspection image printed according to a printer control command generated in step S407 and sent to the image forming apparatus 1500.

To show examples, in FIG. 5, the item 1000 indicates a number of content pages generated, and the item 1001 indicates a number of content copies generated. The item 1000 and the item 1001 are printed to provide count information. For example, if a total number of pages specified in a print job is 1000 and a setting for outputting inspection images is specified as at periods of every 100 pages, 100 inspection images are printed, in which the item 1000 for a print output in which an inspection image is printed will be the 100th page/1000 pages, the 200th page/1000 pages, . . . , and the 1000th page/1000 pages.

This item 1000 is read by the image reading unit 22, and numeric information can be analyzed by an OCR process in the image processing unit 18. In this process, the image processing unit 18 can determine a degree of agreement between evaluation image data stored in the hard disk 13, and image data corresponding to a read inspection image, and determine whether to take or discard a print output stack (lot) printed and discharged.

The loading position of lots determined to have print quality higher than a certain threshold value and the loading position of other lots whose print quality is lower than the threshold value are associated with numbers in the item 1000 read in the OCR process. Therefore, the control program 16 can display the lots whose image quality has some problem and the other acceptable lots in an identifiable form in the operation unit 24, which will be described below.

Consequently, it is possible to easily identify defective print output stacks out of print output stacks which have been discharged.

The paper discharge destination A specified by the printer driver 103 in step S404 and the paper discharge destination B specified in step S406 are different from each other. This is in order that print products of content data and print products of inspection images should be output to different destinations.

In order that print products of all content data are output to a single paper discharge destination and print products of all inspection images are output to another single paper discharge destination, discharge destinations specified in steps S404 and S406 are to be fixed during a single inspection printing operation.

An interface function to specify paper discharge destinations may be provided on the user interface of the printer driver, and when their numbers are supplied to the printer driver 103, the operator can specify a paper discharge destination by selecting its number.

In S408, the printer driver 103 determines, out of generated printer control commands, whether a number of pages of that portion of content data which corresponds to a print command of content data is less than a value of a product of a number of pages of content data, which is printed, multiplied by a number of copies.

If the printer driver 103 determines that the number of pages is less than the value of the product, then in step S415, a generated printer control command is sent through the system spooler 104 to the image forming apparatus 1500, with which the process is finished.

On the other hand, in step S408, if the printer driver 103 determines that the number of pages of that portion of content data which corresponds to print command of content data is not less than the value of the product, the process returns to step S404.

In a setting that, for example, an inspection image is printed at specified inspection periods of 1000 pages, for example, when a content of 300 pages is printed in 20 copies, a print control command, including a print command to produce inspection images as many as five pages, is generated, and sent to the image forming apparatus 1500.

On the other hand, in step S402, if the printer driver 103 determines that the print period of an obtained inspection image is not set by a number of pages, the printer driver 103 further determines whether the print period of an obtained inspection image is by a certain number copies.

If the printer driver 103 determines that the print period of an obtained inspection image is set by a certain number of pages, then in step S409, the printer driver 103 generates a printer control command to specify a paper discharge destination A for print products.

In step S410, the printer driver 103 generates printer control commands for a specified number of copies. At this time, the printer driver 103 performs a process to prevent generated printer control commands from increasing larger than a total number of copies.

In step S411, the printer driver 103 generates a printer control command to specify a paper discharge destination B for print products. In step S412, the printer driver 103 generates a printer control command for an inspection image. A printer control command is added with a command to print information about a number of pages or a number of copies (count information), which have been generated at this timing, at a specified position of the inspection image by overwriting.

A paper discharge destination specified by the printer driver 103 in step S409 and a paper discharge destination specified in step S411 are different from each other. This is in order that print products of content data and print products of inspection image should be output to different discharge destinations. In order that print products of all content data are output to a single paper discharge destination and print products of all inspection images are output to another single paper discharge destination, discharge destinations specified in steps S409 and S411 are to be fixed during a single inspection printing operation.

An interface function to specify paper discharge destinations may be provided on the user interface of the printer driver, and when their numbers are supplied to the printer driver 103, the operator can specify a paper discharge destination by selecting its number.

In step S413, the printer driver 103 determiners, out of generated control commands, whether a number of copies of that portion of content data which corresponds to a print command is equal to or less than a total number of copies of content data, which is printed. Now, if the printer driver 103 determines that, out of generated printer control commands, a number of copies of that portion of content data which corresponds to a print command is not less than a total number of copies of content data which is printed, the process returns to step S409.

In step S413, if the printer driver 103 determines, out of generated printer control commands, whether a number of copies of that portion of content data which corresponds to a print command is equal to or less than a total number of copies of content data, which is printed, the process advances to step S415.

In step S415, a generated printer control command is sent through the system spooler 104 to the image forming apparatus 1500. According to the above flow, the printer driver 103 generates a printer control command to perform inspection printing.

On the other hand, in step S403, if the printer driver 103 determines that the print period of an obtained inspection image is not set by a number of copies, the process proceeds to step S414, in which the printer driver 103 generates a printer control command corresponding to an ordinary printing process, and the process proceeds to step S415.

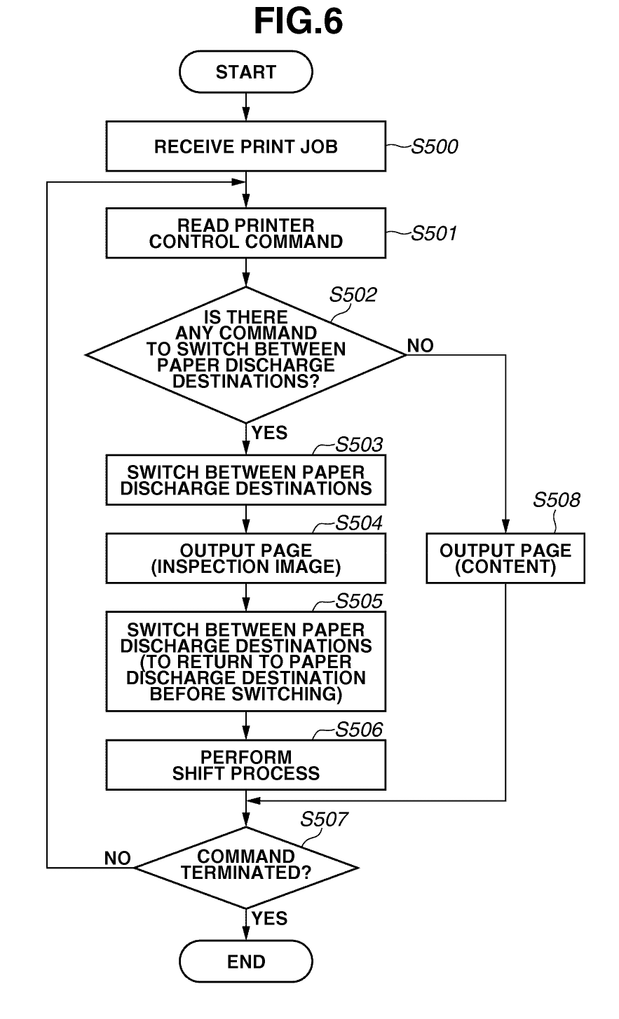

FIG. 6 is a flowchart illustrating a data processing procedure in the image forming apparatus according to the first exemplary embodiment of the present invention. This example illustrates a case where the image forming apparatus 1500 carries out printing when receiving a printer control command for inspection printing from the host computer 3000. Each step is performed when the CPU 10 operates the control program 16, which is loaded in the RAM 11.

In step S500, the image forming apparatus 1500 receives a print job which includes a printer control command sent from the host computer 3000. In step 501, the control program 16 in the image forming apparatus 1500 analyzes the print job and reads the printer control commands page by page.

In step S502, the control program 16 determines whether a paper discharge destination is specified in a printer control command read in step S501. If the control program 16 determines that a paper discharge destination is specified in the read printer control command, then in step S503, the control program 16 specifies a paper discharge destination to the printing unit 20. As described, the control program 16 performs discharge destination control to switch the paper discharge destinations, in other words, either to switch to a paper discharge destination where a print output of inspection images is ejected or to a paper discharge destination where a print output according to a print job is discharged.

On the other hand, in step S502, if the control program 16 determines that a paper discharge destination is not specified in a read printer control command, then in step S508, the control program 16 sends a printer control command interpreted in step S501 to the rendering unit 17. The rendering unit 17 generates image data in a bit map format from a received printer control command, and outputs page data to the printing unit 20.

Because a switchover of paper discharge destinations is specified as described above, print products of inspection image and print products of a content can be ejected to different discharge destinations. A paper discharge destination that can be specified is a destination written in the destination specification in a read printer control command.

In step S504, the control program 16 sends a printer control command interpreted in step S501 to the rendering unit 17. The rendering unit 17 generates inspection image data in a bit map format from received data, and outputs data page by page to the printing unit 20.

In step S505, the control program 16 specifies a paper discharge destination to the printing unit 20. A discharge destination to specify at this time is one before the discharge destination specified in step S503. In step S506, the control program 16 instructs the printing unit 20 to perform a shift process to switch between the paper destinations. On receiving this shift process command, the printing unit 20 performs a shift process to adjust the discharge positions of paper loaded on a paper discharge tray, not shown.

In step S507, the control program 16 determines whether all commands have been read, that is to say, whether all printer control commands have been terminated. If the control program 16 determines that the printer control commands have been terminated, this process is terminated. If the control program 16 determines otherwise, the process returns to step S501.

According to the above flow, the image forming apparatus 1500 performs a printing process for content and controls the paper discharge destinations to print inspection images in order to inspect the status of images of the content, the inspection images being mixed between print jobs and output from between the print jobs during the ongoing printing process.

The above flow illustrates a case where control of the printing process of a content, printing of inspection images to the content, and paper discharge destinations can be realized by generating printer control commands to print inspection images on the host computer 3000. A second exemplary embodiment of the present invention will be described below, which realizes the above control by using inspection images stored in the hard disk 13 in the image forming apparatus 1500.

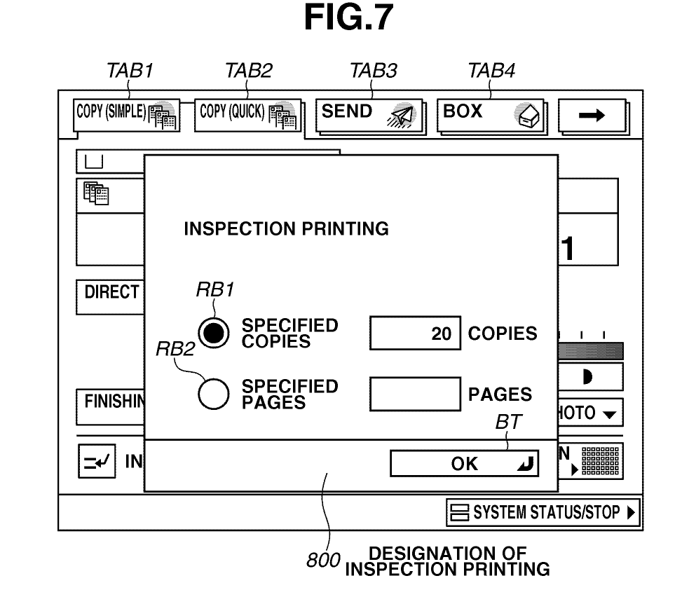

FIG. 7 illustrates an example of the user interface displayed on the touch panel of the operation unit 24 of the image forming apparatus in FIG. 1. In this example, the user interface, including the tab sheets TAB1 to TAB4, is in a status that the tab sheet TAB1 for setting a copy process is selected. This example shows an interface on the image forming apparatus 1500, which is intended to specify inspection printing. The user can set inspection printing to the control program 16 via that interface.

On an inspection-printing setting screen 800 in FIG. 7, a radio button RB1 is selected when the inspection period is set to a specified number of copies, and a radio button RB2 is selected when the inspection period is set to a specified number of pages. At this moment, the radio button RB1 is selected, and “20” is specified as the number of copies. When the button BT is pressed, the selected data is set.

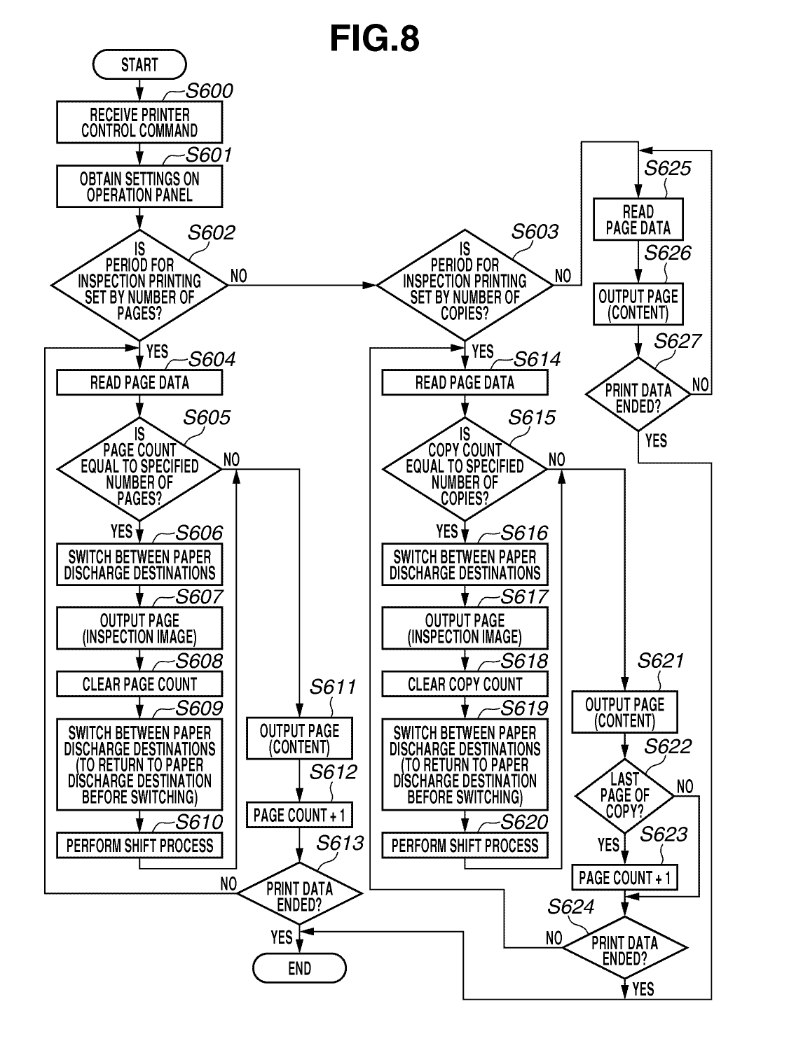

FIG. 8 is a flowchart illustrating an example of a data processing procedure in the image forming apparatus according to the second exemplary embodiment of the present invention. This example shows a process for printing while inspection images are inserted at specified periods when the image forming apparatus 1500 receives a printer control command to print an arbitrary content from the host computer 3000. Each step is realized when the CPU 10 executes the control program 16, which is loaded in RAM 11.

In the second exemplary embodiment, inspection images are arbitrary image data used to check print quality of color charts, and so on, which are previously stored in the hard disk 13 in the image forming apparatus 1500. The image data includes image data to print color charts, an example of which is shown in FIG. 5. Therefore, the items 1000 and 1001 to be selected by the user are printed.

In step S600, the image forming apparatus 1500 receives printer control commands from the host computer 3000. In step S601, the control program 16 obtains settings related to the print period of inspection images specified by the user operating the interface in FIG. 6.

In step S602, to find if inspection printing has been selected, the control program 16 determines whether the print period of inspection images specified by the user is set by a number of pages. If the control program 16 determines that the print period for inspection images is specified by the user by a number of pages, then in step S604, the control program 16 reads printer control commands page by page, and interprets them.

On the other hand, in step S602, if the control program 16 determines that the print period for inspection images specified by the user is not by a number of pages, the process proceeds to step S603.

In step S605, the control program 16 compares the number (page count) of a page counter, which is incremented each time the printing unit 20 is operated by the CPU 10, with the number of pages as the print period of inspection image, obtained in step S601, to see if they are the same number or not. The count on the page counter starts with “0” at the start of the process and will increase or decrease according to the flow.

If the control program 16 determines that the numbers compared are the same, then in step S606, the control program 16 specifies a paper discharge destination to the printing unit 20. As described, the control program 16 controls the discharge destinations to switch between those to receive print output of inspection images and those to receive print output by the print job.

In step S607, the control program 16 generates a printer control command to print an inspection image, stored in the hard disk 13, and information about a number of pages, which have been generated, at a specified position of the inspection image by overwriting, and outputs a page to be sent to the rendering unit 17.

The rendering unit 17 generates inspection image data in a bit map format from received data and sends data to the printing unit 20. Therefore, a print output of the inspection image depicted in FIG. 5 is sent from the printing unit 20 and received at a paper discharge destination different from the paper discharge destination of print data. In this case, with regard to a specified number of pages, inspection images each containing an n-th page and a total number of pages are printed and output as print products.

In step S608, the control program 16 clears the page counter to “0” according to a printer control command. Instep S609, the control program 16 specifies a paper discharge destination to the printing unit 20. The paper discharge destination specified in step S605 and the paper discharge destination specified in step S609 are different from each other. This is in order that print products of content data and print products of inspection images should be output to different discharge destinations.

In order that print products of all content data should be output to a single paper discharge destination and print products of all inspection images should be output to another single paper discharge destination, discharge destinations specified in steps S605 and S609 are to be fixed during a single inspection printing operation.

An interface function to specify paper discharge destinations may be provided on the operation unit 24, and as their numbers are supplied to the control program 16, the operator can specify a paper discharge destination.

In step S610, the control program 16 instructs the printing unit 20 to perform a shift process to switch the paper discharge destinations. On receiving a shift operation command, the printing unit 20 performs a shift process to move the discharge tray of the discharge destination. Then, the process proceeds to step S611.

On the other hand, if the control program 16 determines that the numbers compared in S605 are not the same, the process, without executing steps S606 to S610, advances to step S611. In step S611, the control program 16 sends a printer control command interpreted in step S604 to the rendering unit 17. The rendering unit 17 generates image data in a bit map format from received data, and sends data to the printing unit 20.

In step S612, the control program 16 increments the page counter by +1. Then, in step S613, the control program 16 determines whether the control program 16 has read printer control commands to the last command, in other words, determines whether a stream of print data has been terminated. If the control program 16 determines that print data has been terminated, the process is terminated. If the control program 16 determines otherwise, the process returns to step S604.

On the other hand, if the process turns from step S602 to step S603, the control program 16 determines whether the print period of the confirmed inspection image is set by a number of copies.

If the control program 16 determines that the print period of the confirmed inspection image is set by a number of copies, then in step S614, the control program 16 reads a printer control command for every page to interpret the content.

In step S615, the control program 16 compares the count of the counter managed on the RAM 11 with the number of copies as the print period of inspection image obtained instep S601 to see if they are the same number. The count on the copy counter starts with “0” at the start of the process and will increase or decrease according to the flow.

If the control program 16 determines that the numbers compared are the same, then in step S616, the control program specifies a paper discharge destination to the printing unit 20. As described, the control program 16 controls the discharge destinations to switch between those to receive print output of inspection images and those to receive print output by the print job, in which the switchover is performed at periods of a specified number of copies.

In step S617, the control program 16 generates a printer control command to print a inspection image stored in the hard disk 13 and information about a number of pages, which have been generated at this timing, at a specified position of the inspection image by overwriting. The control program 16 outputs a page to send a generated printer control command to the rendering unit 17. The information about a number of pages corresponds to the item 1001 in FIG. 5.

The rendering unit 17 generates inspection image data in a bit map format from received data, and sends the data to the printing unit 20.

Therefore, the printing unit 20 provides print output illustrated in FIG. 5. In this case, the print period is set by a specified number of pages, inspection images each containing an n-th page and a total number of pages are printed and output as print products.

Then, in step S618, the control program 16 clears the copy counter to “0” according to a print control command. Then, in step S619, the control program 16 specifies a paper discharge destination to the printing unit 20.

The discharge destination specified in step S616 and the discharge destination specified in step S619 are different from each other. This is in order that print products of content data and print products of inspection images should be output to different discharge destinations.

In order that print products of all content data should be output to a single paper discharge destination and print products of all inspection images should be output to another single paper discharge destination, discharge destinations specified in steps S616 and S619 are to be fixed during a single inspection printing operation.

An interface function to specify paper discharge destinations may be provided on the operation unit 24, and as their numbers are supplied to the control program 16, the operator can specify a paper discharge destination.

In step S620, the control program 16 instructs the printing unit 20 to perform a shift process for the paper discharge destinations. On receiving a shift operation command, the printing unit 20 performs a shift process to move the discharge tray of the discharge destination. Then, the process proceeds to step S621.

On the other hand, if the control program 16 determines that the numbers compared in S615 are not the same, the process advances to step S621. In step S621, the control program 16 sends a printer control command interpreted in step S614 to the rendering unit 17. Then, the rendering unit 17 generates image data in a bit map format from received data, and outputs a page to be sent to the printing unit 20.

Then, instep S622, the control program 16 determines whether image data sent instep S621 is the last page of a copy. The method for this determination maybe by giving information when the host computer 3000 generates a printer control command or by comparing a number of pages printed in the image forming apparatus 1500 at the moment and a number of pages of content.

If the control program 16 determines that the above-mentioned sent image data is the last page of a copy, then in step S623, the control program 16 increments the page counter by +1. On the other hand, in step S622, if the control program 16 determines that the sent image data is not the last page of a content, the process advances to step S624.

In step S624, the control program 16 determines whether the control program 16 has read printer control commands to the last command, in other words, determines whether a stream of print data has been terminated. If the control program 16 determines that a stream of print data has not been terminated, the process returns to step S614. If the print data has been terminated, the process is finished.

On the other hand, in step S603, if the control program 16 determines that the print period of the confirmed inspection image is not by a number of copies, that is to say, if the control program 16 that the print period has not been set in step S602 and in step S603, the process advances to step S625.

In step S625, the control program 16 reads printer control commands page by page to interpret each page. In step S626, the control program 16 outputs a printer control command interpreted in step S625 and outputs a page to be sent to the rendering unit 17. The rendering unit 17 generates image data in a bit map format from received data, and sends the data to the printing unit 20.

In step S627, the control program 16 determines whether the control program 16 has read the printer control commands to the last command, in other words, determines whether print data has been terminated. If the control program 16 determines that print data has not been terminated, the process returns to step S625. If the control program 16 determines that print data has been terminated, this process is finished.

Steps 5625 to 5627 are the steps to be executed when inspection printing is not performed.

In the following, a process will be described in which print quality inspection is performed for print products which are printed and ejected by comparing image data obtained by reading a plurality of print products of inspection images in the first and the second exemplary embodiments with evaluation image data which is stored.

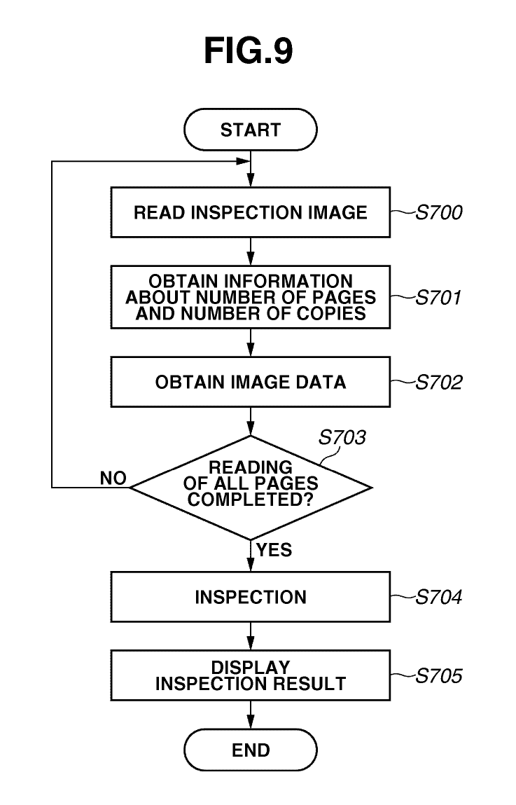

FIG. 9 is a flowchart illustrating an example of a data processing procedure in the image forming apparatus according to an exemplary embodiment of the present invention. This example concerns an inspection process with the image forming apparatus 1500, which uses print products and inspection images of content. Each step can be realized by executing a control program 16, which is loaded in the RAM 11 by the CPU 10.

In step S700, the image forming apparatus 1500, through the image reading unit 22, reads print products of inspection images, which are discharged according to the flows of FIGS. 6 and 8.

In step S701, information about a number of pages or a number of copies is obtained from inspection images read by the image reading unit 22 by using an OCR process, for example. The information about a number of pages or a number of pages can be obtained in step S407, S412, or S607.

In step S702, the control program 16 obtains image data read by the image reading unit 22. Then, in step S703, the control program 16 determines whether reading of all printed inspection images has been completed. If the control program 16 determines that reading of all printed inspection images has been completed, the process advances to step S704. If the control program determines otherwise, the process returns to step S700.

In step S704, the image forming apparatus 1500 performs an inspection process to inspect a print product of an inspection image. Regarding the inspection process, any method may be used as long as the method can evaluate an image status of a read inspection image.

As an example of an inspection process, an inspection process will be described which uses color differences at pixels by comparing read image data with evaluation image data as a quality standard to find a degree of agreement therebetween.

The control program 16 finds a sum of color differences at the respective pixels between image data read by the image reading unit 22 and evaluation image data as a quality standard. If it is determined that its value is equal to or higher than a threshold value, the control program 16 determines that the image data has some problem in quality. As described above, in the present exemplary embodiment, because a degree of agreement is decided between image data read from an inspection image and the evaluation image data serving as a quality standard, it is possible to determine that there is a problem in print output printed based on a print job, which is ejected just before the inspection image is output.

A certain threshold value used above maybe maintained at a fixed value by default in the image forming apparatus or may be input from the operation unit 24.

The control program 16 in the image forming apparatus 1500 makes a determination to all of read image data, and keeps a page number or a copy number of image data determined to have a problem.

With regard to image data as a quality standard, in the flow illustrated in FIG. 8, because inspection images are stored in the hard disk 13 of the image forming apparatus 1500, this image data is used.

In the flows in FIGS. 4 and 6, inspection images similar to the inspection images previously stored in the hard disk 4 of the host computer 3000 are stored in the hard disk 13 of the image forming apparatus 1500 and used as inspection images.

The rendering unit 17 may use a bit map rendered in step S504 as an inspection image.

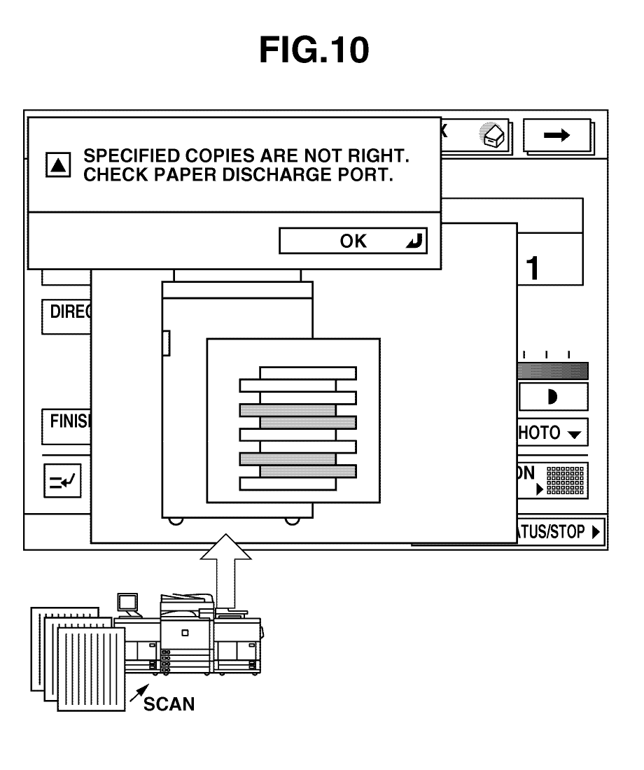

In step S705, the image forming apparatus 1500 displays an inspection result on the panel display of the operation unit 24 according to an inspection result obtained in step S704. At this time, an inspection result is clearly demonstrated in the display method in which a number of pages and a number of copies of a print product of an inspection image determined to be defective are associated with print products of content ejected at the paper discharge destinations. More specifically, on a print output paper of an inspection image depicted in FIG. 5, count information according to inspection image output timing specified by a user is provided by using an OCR process, a correspondence relationship of the output paper to the print product stacks can be understood. Therefore, according to a result of determination of the image status of a print product on which the inspection image is printed, one can easily find a corresponding defective print output stack. Since the paper discharge positions are adjusted to different print jobs by a shift process for the paper discharge destinations, a defective print output stack (lot) as illustrated in FIG. 10 and other print output stacks can be identified.

In relation to a page number or a copy number of image data determined to be defective and held in step S704, it is determined that lots adjacent to the lot with those page number or copy number are highly likely to be defective, and necessary messages are displayed on the screen panel of the operation unit 24 shown in FIG. 10.

If a total number of lots is ten and an inspection image from the second and the third lot and an inspection image from the sixth to the seventh lot inclusive have a picture quality problem, the result of inspection is notified to the operator by painting the relevant portions black as illustrated in FIG. 10. Thus, the user can identify the defective lots and the other lots, and a correspondence relation between the discharged print outputs and the lots is shown, the operator can accurately pick out the defective lots from all the lots.

Each time an inspection image is printed in steps S506, S610, and S620, the printing unit 20 carries out the shift process, so that defective inspection images can be associated with pages, copies, and destinations of print products.

The shift operation carried out by the printing unit 20 in steps S506, S610, and S620 is to clearly show the positions where the inspection images are inserted, and as its method, any method may be adopted as long as it can clearly indicate the inserted positions by using partitioning sheets or rotating print products.

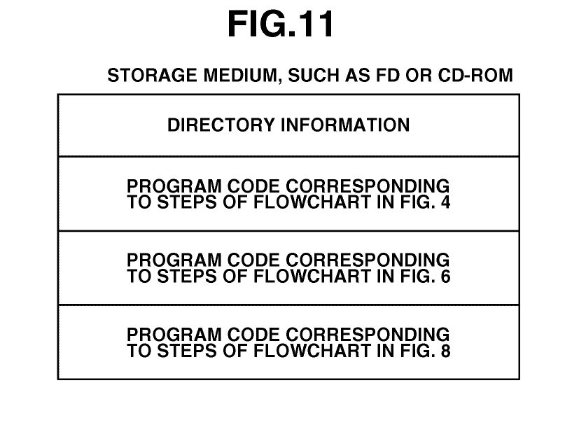

FIG. 11 is a diagram illustrating a memory map of a storage medium to store various types of data processing programs that can be read in an image forming system including an information processing apparatus and an image forming apparatus according to an exemplary embodiments of the present invention. The storage medium may be configured as an independent one separately installed in the information processing apparatus and the image forming apparatus.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-267730 filed Oct. 16, 2008, which is hereby incorporated by reference herein in its entirety.

What is claimed is:

1. An image forming apparatus configured to process a print job received from an information processing apparatus, the image forming apparatus comprising:
a plurality of paper discharge units configured to discharge a print output printed by a printing unit;
a print control unit configured to have an inspection image mixed in an output of image data and to output the inspection image with the output of the image data, the inspection image being used to inspect a state of an image printed by the printing unit based on image data generated according to the print job;
a paper discharge control unit configured to switch between a first paper discharge destination to receive a print output printed by the printing unit based on the inspection image data and a second paper discharge destination to receive a print output printed by the printing unit based on image data of each page;
a reading unit configured to read the inspection image of the print output discharged to the paper discharge control unit; and
a display unit configured to compare the inspection image data read by the reading unit with evaluation image data previously stored to check a degree of agreement therebetween, and to display a result of print quality inspection of a print output stack printed based on the image data of each page.

2. The image forming apparatus according to claim 1, further comprising a specifying unit configured to specify an inspection image output mode for mixing the inspection image in the output of the image data and to output the inspection image with the output of the image data.

3. The image forming apparatus according to claim 1, further comprising a shift processing unit configured to make a shift in paper discharge positions of one of the plurality of paper discharge units each time the paper discharge control unit switches between the paper discharge destinations,
wherein the display unit displays a result of print quality inspection of each print output stack for which the shift has been made by the shift processing unit and which has been discharged.

4. The image forming apparatus according to claim 2, wherein the specifying unit is configured to output the inspection image at periods of a predetermined number of copies or pages.

5. The image forming apparatus according to claim 1, further comprising an identification unit configured to identify count information, extracted from image data read by the reading unit, out of a print output printed by the printing unit based on the inspection image data,
wherein the display unit displays a result of print quality inspection of each print paper stack loaded on one of the plurality of paper discharge units based on the count information identified by the identification unit.

6. An image inspection method for an image forming apparatus configured to process a print job received from an information processing apparatus, the image forming apparatus including a plurality of paper discharge units configured to discharge a print output printed by a printing unit, the image inspection method comprising:
having an inspection image mixed in an output of image data and outputting the inspection image with the output of the image data, the inspection image being used to inspect a state of an image printed by the printing unit based on image data generated according to the print job;
switching between a first paper discharge destination to receive a print output printed by the printing unit based on the inspection image data and a second paper discharge destination to receive a print output printed by the printing unit based on image data of each page;
reading the inspection image data of the print output discharged to the paper discharge unit; and
comparing the read inspection image data with evaluation image data previously stored to check a degree of agreement therebetween, and displaying a result of print quality inspection of a print output stack printed based on the image data of each page.

7. The image inspection method according to 6, further comprising specifying an inspection image output mode to have the inspection image mixed in the output of the image data and outputting the inspection image with the output of the image data, the inspection image being used to inspect a state of an image printed by the image forming apparatus based on the image data generated from the print job.

8. The image inspection method according to claim 6, further comprising:
making a shift in paper discharge positions of one of the plurality of paper discharges unit to which a print output is discharged based on the image data each time a shift is made between the paper discharge destinations; and
displaying each print output stack associated with a result of print quality inspection, each print output stack having been discharged after the shift has been made.

9. The image inspection method according to claim 7, further comprising specifying an inspection image output mode to output an inspection image at a rate of a predetermined number of copies or pages after having the inspection image mixed in an output of the image data.

10. The image inspection method according to claim 6, further comprising:
identifying count information, extracted from read image data, out of a print output printed based on the inspection image data; and
displaying a result of print quality inspection of each print paper stack loaded on the paper discharge unit based on the identified count information.

11. A computer-readable storage medium storing a program for causing a computer to execute the image inspection method according to claim 6.
